(19) United States
(12) Patent Application Publication
(10) Pub. No.: US 2003/0081996 A1
(43) Pub. Date: May 1, 2003

(54) LCD frame and bracket mounting arrangement

(75) Inventors: Kai-Yu Sun, Hsinchu Hsien (TW); Yu-Hsiu Chang, Hsinchu City (TW)

Correspondence Address: BRUCE H. TROXELL, 5205 LEESBURG PIKE, SUITE 1404, FALLS CHURCH, VA, 22041, US

(73) Assignee: AU Optronics Corporation

(21) Appl. No.: 10/251,999

(22) Filed: Sep. 23, 2002

(30) Foreign Application Priority Data
Oct. 31, 2001 (TW) 090218640

(51) Int. Cl. B25G 3/08

(52) U.S. Cl. 403/381

(57) ABSTRACT

A LCD frame and bracket mounting arrangement is constructed to include a frame with a screw hole at one side, a coupling block, the coupling block having a bottom screw rod threaded into the screw hole of the frame and a top retaining notch, and a bracket, the bracket having an opening for receiving the coupling block and a spring plate suspended in the opening in, the spring plate having a retaining block adapted for engaging the top retaining notch of the coupling block to secure the bracket to the coupling block and the frame.

### BACKGROUND OF THE INVENTION

1. Field of the Invention:

The present invention relates to a LCD module and, more specifically, to a LCD frame and bracket mounting arrangement.

2. Description of the Related Art:

A variety of display devices are commercially available for output of information from a computer. Currently, LCDs are commonly used in personal computers, notebook computers, VCD/DVD players, PADs, etc. A LCD module is comprised of a display panel, and a frame fixedly provided around the display panel. The frame of a LCD module is fixedly mounted with a bracket for installation in a computer, VCD/DVD players, PADs, etc. FIG. 1 shows a LCD frame and bracket mounting arrangement according to the prior art. According to this arrangement, the frame A has screw holes B, and the bracket C has through holes D respectively fastened to the screw holes B of the frame A by a respective screw E. This mounting procedure is achieved by means of the use of a screwdriver. Further, when installed, the presence of the screws E in the outside wall of the bracket C destroys the sense of unity beauty of the assembly.

### SUMMARY OF THE INVENTION

The present invention has been accomplished under the circumstances in view. It is therefore the main object of the present invention to provide a. LCD frame and bracket mounting arrangement, which can easily be assembled without the use of any hand tool. It is another object of the present invention to provide a. LCD frame and bracket mounting arrangement, which causes a sense of unity beauty. To achieve these and other objects of the present invention, the LCD frame and bracket mounting arrangement comprises a frame, the frame having a screw hole in one peripheral sidewall thereof; a coupling block, the coupling block having a bottom screw rod adapted for fastening to the screw hole of the frame and a top retainer means; and a bracket, the bracket having a top wall and a front sidewall arranged at right angles, an opening in the front sidewall for receiving the coupling block, a spring plate suspended in the opening in substantially parallel to the top wall, the spring plate having retainer means adapted for engaging the top retainer means of the coupling.

### BRIEF DESCRIPTION OF THE DRAWINGS

FIG. 1 is an exploded view of a LCD frame and bracket mounting arrangement according to the prior art.

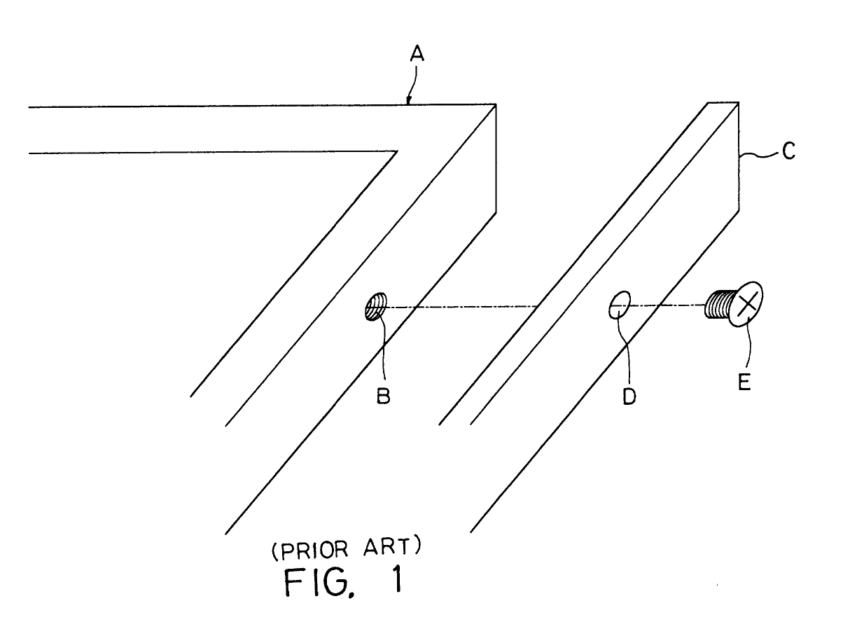

FIG. 2 is an exploded view of a LCD Frame and bracket mounting arrangement according to the present invention.

### DETAILED DESCRIPTION OF THE PREFERRED EMBODIMENT

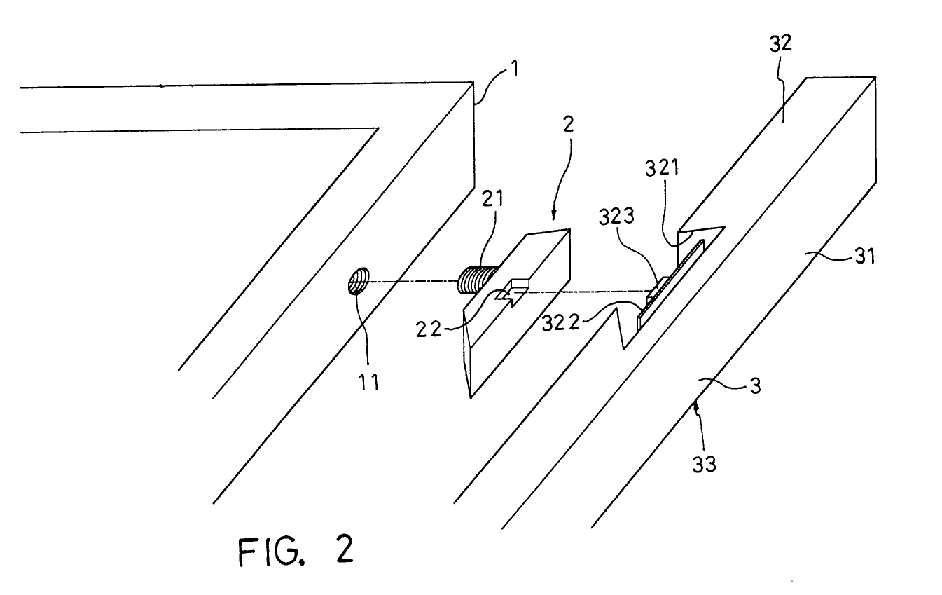

Referring to FIG. 2, a LCD frame and bracket mounting arrangement in accordance with the present invention is shown comprised of a frame 1, a coupling block 2, and a bracket 3.

The frame 1 is adapted to hold a display panel on the inside, having a screw hole 11 in one sidewall for the mounting of the coupling block 2.

The coupling block 2 is a solid block having a predetermined profile. According to this embodiment, the coupling block 2 is a dovetail block having a downwardly extended bottom screw rod 21 adapted for threading into the screw hole 1 of the frame 1, and a retaining notch 22 in the top for coupling to the bracket 3.

The bracket 3 is bent from a sheet member into shape, having an elongated top wall 31, elongated front and back sidewalls 32 and 33 respectively perpendicularly extended along two opposite long sides of the elongated top wall 31 and arranged in parallel, a dovetail opening 321 in front sidewall 32 corresponding the coupling block 2, a spring plate 322 suspended inside the dovetail opening 321, and a retaining block 323 downwardly protruded from the spring plate 322 corresponding to the retaining notch 22 of the coupling block 2. As an alternate form of the present invention, the bracket 3 can be extruded from metal in a solid or hollow form. The spring plate 322 and the retaining block 323 can be fastened to the bracket 3 by screw means or welding.

The assembly process of the present invention is outlined hereinafter. At first, the bottom screw rod 21 of the coupling block 2 is threaded into the screw hole 11 of the frame 1. Because the coupling block 2 is made in the form of a hand screw, it can easily be fastened to the screw hole 11 of the frame 1 by hand without the use of a screwdriver. After installation of the coupling block 2 in the frame 1, the frame I is attached to the bracket 3 to force the coupling block 2 into the dovetail opening 321 of the bracket 3, keeping the retaining block 323 hooked in the retaining notch 22.

When separating the bracket 3 from the frame 1 and the coupling block 2, pull the spring plate 322 to disengage the retaining block 323 from the retaining notch 22.

A prototype of LCD frame and bracket mounting arrangement has been constructed with the features of FIG. 2. The LCD frame and bracket mounting arrangement functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A LCD frame and bracket mounting arrangement comprising:
a frame, said frame having fixed fastening means;
a coupling block, said coupling block having first fixed fastening means at a first side thereof adapted for fastening to the fixed fastening means of said frame and a second fixed fastening means at a second side thereof opposite to said first side; and
a bracket, said bracket having a top wall and a front sidewall arranged at right angles, an opening in said front sidewall for receiving said coupling block, and fastening means provided inside said opening and adapted for fastening to the second fixed fastening means of said coupling block to secure said bracket to said coupling block and said frame.

2. The LCD frame and bracket mounting arrangement as claimed in claim 1, wherein the fixed fastening means of said frame is a screw hole; the first fixed fastening means of said coupling block is a screw rod extended downwardly from a bottom side of said coupling block and adapted for threading into the screw hole of said frame.

3. The LCD frame and bracket mounting arrangement as claimed in claim 1, wherein said bracket further has a back sidewall adapted to cover with the top wall and front sidewall of said bracket on top, front and back sides of one peripheral sidewall of said frame over said coupling block.

4. The LCD frame and bracket mounting arrangement as claimed in claim 1, wherein said coupling block is a dovetail block fitting the opening of said bracket; the second fixed fastening means of said coupling block is a retaining notch; the fixed fastening means of said bracket comprises a retaining block adapted to engage the retaining notch of said coupling block.

5. The LCD frame and bracket mounting arrangement as claimed in claim 1, wherein said bracket is a solid member.

6. The LCD frame and bracket mounting arrangement as claimed in claim 1, wherein said bracket can be provided at two sides of said frame.

7. The LCD frame and bracket mounting arrangement as claimed in claim 1, wherein said bracket can be provided at four sides of said frame.

8. A LCD frame and bracket mounting arrangement comprising:
a frame, said frame having a screw hole in one peripheral sidewall thereof;
a coupling block, said coupling block having a bottom screw rod adapted for fastening to the screw hole of said frame and a top retainer means; and
a bracket, said bracket having a top wall and a front sidewall arranged at right angles, an opening in said front sidewall for receiving said coupling block, a spring plate suspended in said opening in substantially parallel to said top wall, said spring plate having retainer means adapted for engaging the top retainer means of said coupling block.

9. The LCD frame and bracket mounting arrangement as claimed in claim 8, wherein the top retainer means of said coupling block is a retaining notch; the retainer means of said spring plate of said bracket is a retaining block.

10. The LCD frame and bracket mounting arrangement as claimed in claim 8, wherein said bracket further has a back sidewall perpendicularly extended from said top wall and arranged in parallel to said front sidewall.
